(19) United States
(12) Patent Application Publication
(10) Pub. No.: US 2008/0282283 A1
(43) Pub. Date: Nov. 13, 2008

(54) Method And System For Processing Commerce Transactions In An Interactive Environment

(75) Inventors: Antony A. Hilton, New York, NY (US); Gregory L. Hilton, New York, NY (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: ICE, L.L.C.

(21) Appl. No.: 12/119,333

(22) Filed: May 12, 2008

Related U.S. Application Data
(60) Provisional application No. 60/917,557, filed on May 11, 2007.

(51) Int. Cl. H04N 7/16; H04N 7/173

(52) U.S. Cl. 725/5; 725/86; 725/131

(57) ABSTRACT

A method and system for processing commerce transactions between a consumer and a business in an interactive environment is disclosed. According to one embodiment, a computer-implemented method, comprises generating a request package from commands received at a set top box. The request package is received over a cable network. The request package includes a product identifier. Product information is retrieved from a product database using the product identifier. Vendor information is retrieved using the product identifier; and a vendor fulfillment package is sent to a deployment server.

The present application claims the benefit of and priority to U.S. Provisional Patent Application No. 60/917,557 entitled “Consumer Purchase Requests In An Interactive TV Environment” and filed on May 11, 2007, and is hereby incorporated by reference in its entirety.

### FIELD

The field of the invention relates generally to interactive television as well as to all other areas of electronic commerce and more particularly relates to a method and system for processing commerce transactions between a consumer and a business in an interactive environment.

### BACKGROUND

Both television commerce (T-Commerce) and electronic commerce (E-commerce) have limited functionalities in processing transactions in today's interactive commerce environment. Implementation of T-commerce has been interfered by the common belief that T-commerce can be implemented based on existing Web-based merchant service systems. Moreover, the proprietary nature of such Web-based merchant services, typically contained within a walled-garden platform, discourages two-way communication between outside services and users, thus has further limited proper implementation of T-commerce.

On the other hand, E-commerce is limited because of the belief that vendors providing commerce services must not only carry inventory of products but also acquire—and usually pay for—third party or self-created merchant service system to sell products to consumers via the Internet.

In general, one of the most significant challenges facing T-commerce is the processing of transactions on behalf of consumers. The nature of interactive TV (iTV) architecture historically has been one of custom-coded proprietary solutions designed for custom implementation. These designs are meant to work with specific multimedia service providers called Multi-Service Organizations (MSOs).

It is widely but erroneously believed that T-commerce closely resembles a generic Web-based storefront model of E-commerce replicated in a television broadcasting environment. E-commerce is limited to models that mimic, in a great way, the traditional brick-and-mortar commerce model of the past, so its infrastructure and the communication method between an individual consumer and a business cannot properly establish environment for T-commerce.

The fundamental difference between the foundation of E-commerce, typically via the Internet, and the foundation of T-commerce, via broadcast systems, is best understood by looking at the history therebehind. The Internet was built as a way for traditional two-way communication to between two parties in a similar way as telephone systems. Television broadcasting, however, was not built upon the same principle. Television was developed to display imagery in the form of information (e.g., news) or entertainment (e.g., movies, dramas). As such, the infrastructure of the television broadcasting system was not developed to facilitate the same form of information exchange as was previously conceived by telephone systems and other communication-based systems.

For these reasons, the solution and model that has been developed for E-commerce does not fit well for T-commerce. In light of these differences in the birth and evolution of T-commerce and E-commerce, there is a need for a system and method for processing commerce transactions in an interactive environment that overcomes various issues associated therewith.

### SUMMARY

A method and system for processing commerce transactions between a consumer and a business in an interactive environment is disclosed. According to one embodiment, a computer-implemented method, comprises generating a request package from commands received at a set top box. The request package is received over a cable network. The request package includes a product identifier. Product information is retrieved from a product database using the product identifier. Vendor information is retrieved using the product identifier; and a vendor fulfillment package is sent to a deployment server.

The above and other preferred features, including various novel details of implementation and combination of elements, will now be more particularly described with reference to the accompanying drawings. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates an exemplary architecture of a commerce transactional system for providing two-way communication between consumers and vendors, according to one embodiment;

FIG. 2 illustrates an exemplary process for delivering a consumer's purchase request to vendors, according to one embodiment;

FIG. 3 illustrates an exemplary process of constructing vendor fulfillment packages from request packages, according to one embodiment;

FIG. 4 illustrates an exemplary processes for processing payment of a consumer's request, according to one embodiment;

FIG. 5 illustrates an exemplary process for distributing vendor fulfillment packages to vendors, according to one embodiment;

FIG. 6 illustrates an exemplary process for updating product and vendor information, according to one embodiment; and

FIG. 7 illustrates an exemplary computer architecture for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION

A method and system for processing commerce transactions between a consumer and a business in an interactive environment is disclosed. According to one embodiment, a computer-implemented method, comprises generating a request package from commands received at a set top box. The request package is received over a cable network. The request package includes a product identifier. Product information is retrieved from a product database using the product identifier. Vendor information is retrieved using the product identifier; and a vendor fulfillment package is sent to a deployment server.

Each of the features and teachings disclosed herein can be utilized separately or in conjunction with other features and teachings to provide a method and system for vision-based interaction in a virtual environment. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense, and are instead taught merely to describe particularly representative examples of the present teachings.

In the following description, for the purposes of explanation, specific nomenclature is set forth to facilitate an understanding of the various inventive concepts disclosed herein. However, it will be apparent to one skilled in the art that these specific details are not required in order to practice the various inventive concepts disclosed herein.

The present invention also relates to systems for performing the operations herein. This system may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus.

The methods presented herein are not inherently related to any particular computer or other system. Various general-purpose systems may be used with programs in accordance with the teachings herein, or it may prove convenient to construct more specialized system to perform the required method steps. The required structure for a variety of these systems will appear from the description below. In addition, the present invention is not described with reference to any particular programming language. It will be appreciated that a variety of programming languages may be used to implement the teachings of the invention as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Interactive video commerce (IVC) is a unique, ubiquitous software technology that combines menus, client content cataloguing and collection, home user interfacing, user authentication, shopping cart, user transaction processing, communication and tracking. IVC is designed to be flexible by providing effective development and deployment of successful interactive services to set-top boxes (STB) and television sets. Users equipped with such software platform is provided with “on demand” on-screen menu that grants access to the interactive services with a standard TV/Cable box remote control.

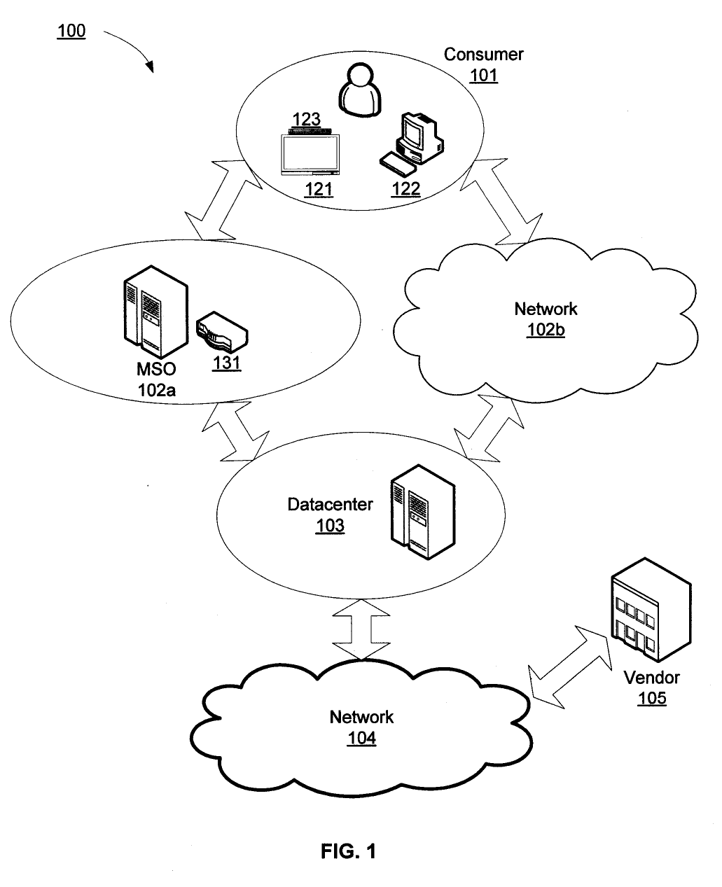

FIG. 1 illustrates an exemplary architecture of a commerce transactional system 100 for providing two-way communication between consumers and vendors, according to one embodiment. The two-way communication between consumer 101 and vendor 105 (e.g., a brand company, a merchant, a manufacturer, a retailer, a distributor) provides a commerce platform through either a television broadcasting platform or a network platform. Two-way communications enable consumer 101 to exchange data with datacenter 103, and ultimately with vendor 105, to facilitate commerce transactions in an interactive fashion.

Consumer 101 has a television set 121 or a computer 122 with network connectivity to datacenter 103. Consumer 101 makes a purchase for a product and sends a purchase request using a store front-end interface available on his/her television set 121 or computer 122. For example, the store front-end interface is a menu system within a set-top box (STB) 123 provided by an MSO such as cable, satellite or IPTV service companies. An independent STB (e.g., TiVo by TiVo Inc., tru2way™ by Panasonic) might be used as well. According to one embodiment, these front-end menu systems and the two-way communication system upon which they work may take any form of transaction request, such as the industry standard Open Cable Application Platform (OCAP) developed under the OpenCable initiative.

Consumer 101's purchase request is delivered to datacenter 103 through two-way communication platform 102. According to one embodiment, consumer 101 communicates with datacenter 103 via MSO system 102a. In this case, consumer 101's STB 123 is connected to MSO 102a and receives updated product information as well as transmitting consumer 101's purchase request to datacenter 103. According to another embodiment, consumer 101 has a direct connection with datacenter 103 over network 102b. For example, consumer 101 shops at an online store on the Internet and the purchase request is transmitted to datacenter 103. In an alternate embodiment, an online service tags a JavaScript widget onto an online advertisement. According to this embodiment, the JavaScript widget allows for a commerce microsite to be accessible by consumers simply by clicking the online advertisement. The microsite acts like an E-commerce website providing product details and options, and the ability to buy through the JavaScript widget.

Consumer 101 may also transmit other requests for administrative purposes, for example, requests for updating account information, shipping addresses, billing addresses, account passwords or the like. In addition, consumer 101's request might be the request for additional information from MSO 102a, datacenter 103 or vendor 105. Consumer 101's request is received and processed by commerce transactional system 100 and further communication regarding the status of the requests or the requested information may follow.

Datacenter 103 stores not only consumer 101's account information but also transactional history or any other information required to operate commerce transaction system 100. Consumer 101's purchase request may contain an email, or any other form of data or instruction directed to MSO 102a, datacenter 103 or vendor 105. Datacenter 103 may be located anywhere it may connect to network 104. Consumer 101's transaction request is first received by a processing server residing either within datacenter 103 or MSO 102a. According to one embodiment, the processing server can use a metering device 131 (e.g. DigiHost by Digisoft.tv) for tracking consumer initiated transactions and acts as a gateway between STB 123 and datacenter 103. The flexible placement of processing server provides various integration options. Upon receipt of the consumer 101's request, datacenter 103 processes and then distributes it via network 104 (e.g., the Internet) to vendor 105.

According to one embodiment, the present method and system provides a user interface for consumer 101 to create, form and transmit consumer 101's requests. Consumer 101's transaction request is transmitted and processed as a communication packet over the network 104. Datacenter 103 exists in the center of the transaction between consumer 101 and vendor 105, receiving the transaction request from consumer 101 and redistributing them to vendors 105 for fulfillment.

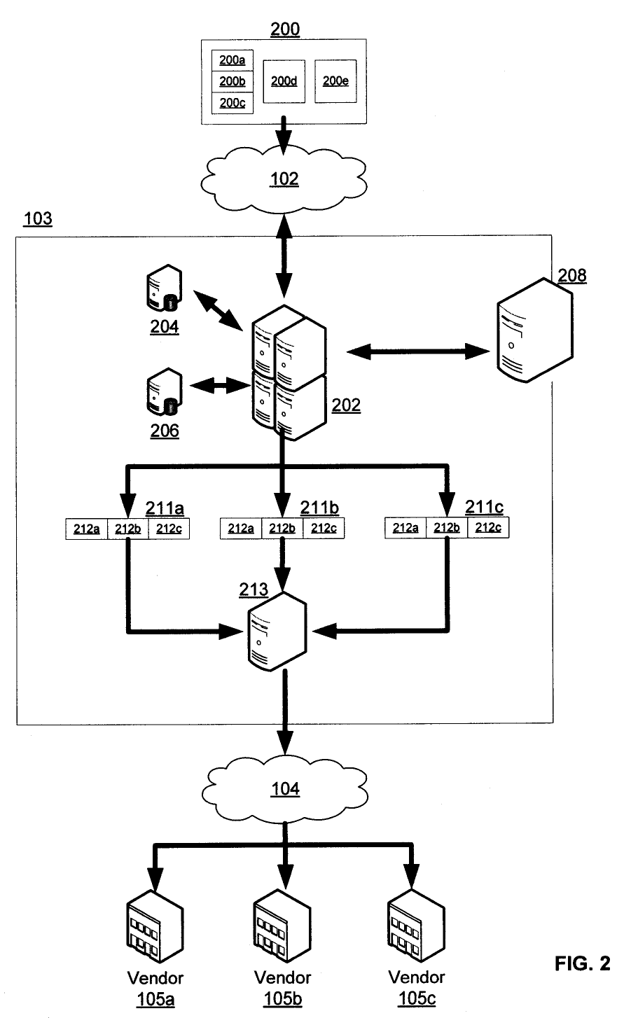

FIG. 2 illustrates an exemplary process for delivering a consumer's purchase request to vendors, according to one embodiment. Request package 200 contains data pertaining to the consumer 101's purchase request. For example, request package 200 contains one or more product's data 200a-200c that includes product identification tags and product options such as color, size, quantity, and consumer 101's data 200d such as shipping address, billing address, phone number and email address. Request package 200 also contains transactional data including the total cost and payment information 200e (e.g., credit card account number, PayPal account, bank account number). In one embodiment, consumer 101's data 200d and payment information 200e are already available at datacenter 103 or datacenter 103 knows how to recover that data and information available elsewhere to complete consumer 101's purchase request. In such cases, consumer 101's data 200d and payment information 200e are not included in request package 200 and request package 200 is securely delivered to datacenter 103 with proper authorization from consumer 101.

Consumer 101's request package 200 is delivered to datacenter 103 via communication platform 102 of choice (e.g., via MSO 102a or network 102b). Communication platform 102 may vary depending on how the commerce transaction system is constructed and how it operates. For example, if consumer 101 uses television set 121 and STB 123 for product purchase, MSO 102a's system may be involved in delivering product information and purchase request between consumer 101 and datacenter 103. In alternate embodiments, consumer 101 may use the JavaScript widget described above to purchase a product over network 102b. If consumer 101 purchases products online using computer 122 or STB 123 with a network 102b access, consumer 101's purchase request is directly delivered via network 102b to datacenter 103 for processing and transmission to vendor 105 for fulfillment.

Processing server 202 receives request package 200 and begins processing the purchase request from consumer 101. To display the products to consumer 101, the front-end menu system 303 includes a primary product tag to be used by product database 204. The database system uses this product tag to identify all product data intended for display. All product data is identified by its own product tag, such as a SKU number. Once identified, all product data, including the product tag number, is sent to the front-end menu system 303 for display to consumer 101. When consumer 101 submits a request package 200, the product tag is sent with the request package 200 for processing system 202 to process the purchase request. In this example, the product tags of consumer-selected products 200a-200c are used to collect product data from product database 204. According to one embodiment, only the product tag and optionally, the consumer 101's preferences are used to access product database 204 to limit the amount of data exchanged between processing server 202 and product database 204.

According to one embodiment, menu system 303 detects the product tag and transmits it to datacenter 103, which uses the tag to identify all the products associated with the program being accessed by menu system 303. The product information is associated with its own tag, a SKU. Product data is sent back to menu system 303 for display. Consumer 101 selects the products and submits a purchase request through menu system 303. Menu system 303 transmits back the SKU and other consumer information. Datacenter 103 receives the information and identifies the product again to identify a vendor so that the purchase request is sent to the correct vendor for fulfillment.

According to another embodiment, the JavaScript widget described above has an associated widget identification number. When the JavaScript widget is activated or selected by consumer 101, the JavaScript widget sends a request to datacenter 103 with its widget identification number. Datacenter 103 receives the widget identification number and accesses product database 204 that contains all the product information and SKU cataloguing numbers to find the product associated with that widget identification number. Datacenter 103 sends the display data to the JavaScript widget. When consumer 101 chooses to buy the product, the JavaScript widget sends the SKU number back with consumer data (e.g., payment information, size, quantity, shipping terms, etc.). Once this information is collected, it is sent to the correct vendor for fulfillment as described below.

Product database 204 contains a catalog of product information. When MSO 102a is involved in communicating with consumer 101, the product information is updated and sent out to the front-end menu system within STB 123 for display to consumer 101. Each product has an identifier tag, such as an SKU number, that is used by the front-end menu system to pull product data from product database 204 for display when consumer 101 views specific content, for example, a TV show or online advertisement. Product tags are also used by processing server 202 to identify the products that are selected by the consumer 101 as submitted and received within request package 200. Processing server 202 also accesses vendor database 206 to identify a vendor 105 who sell the product. Vendor database 206 is queried with the product tag and vendor information is collected by processing system 202.

Payment information 200e may be processed by processing server 202 in various ways. According to one embodiment, payment information 200e is processed by an independent payment processing system 208. Payment processing system 208 processes monetary transactions, at the request of processing server 202, using consumer 101 's credit card or by other payment method such as virtual check or PayPal. Payment processing system 208 communicates with the financial institution designated by payment information 200e and receives notification whether the transaction request is accepted or denied. When the transaction was successful, processing server 202 includes processed payment information 212c in vendor fulfillment package 211 as a verification for successful transaction. When the transaction request is denied, processing server 202 notifies consumer 101 of a failed transaction.

According to another embodiment, payment processing system 208 is implemented within datacenter 103 with direct dealings with financial institutions such as credit card companies or banks. If there are insufficient funds, processing server 202 returns a message to consumer 101 of insufficiency of fluids and voids the transaction request. If there are sufficient funds, merchant system 208 sends a confirmation to processing server 202. The confirmation received by processing server 202 is included in vendor fulfillment package 211 as processed payment information 212c.

According to yet another embodiment, processing server 202 includes payment information 212c as part of vendor fulfillment package 211. After receiving vendor fulfillment package 211 including payment information 212c, vendor 105 processes the payment request using their own transactional system. Vendor 105's payment processing also involves communication with the financial institution designated by payment information 200e in a similar way as payment processing system 208 processes payment requests in association with the financial institution.

Processing server 202 separates collected data and prepares vendor fulfillment packages for each vendor 105. Each vendor fulfillment package includes product data 212a, shipping information 212b as referenced by data 200d, and payment information 212c that is processed by processing server 202. Next, vendor fulfillment packages 211 prepared by processing server 202 are delivered to deployment server 213. Deployment server 213 directs the vendor fulfillment packages 211 to their specific destination, based on the tag information of the product and brand. Delivery information for each vendor is stored in vendor database 206, deployment server 213 or a database on or off datacenter 103. Vendor fulfillment packages 211 are then delivered via network 104 to designated vendors 105a-105c.

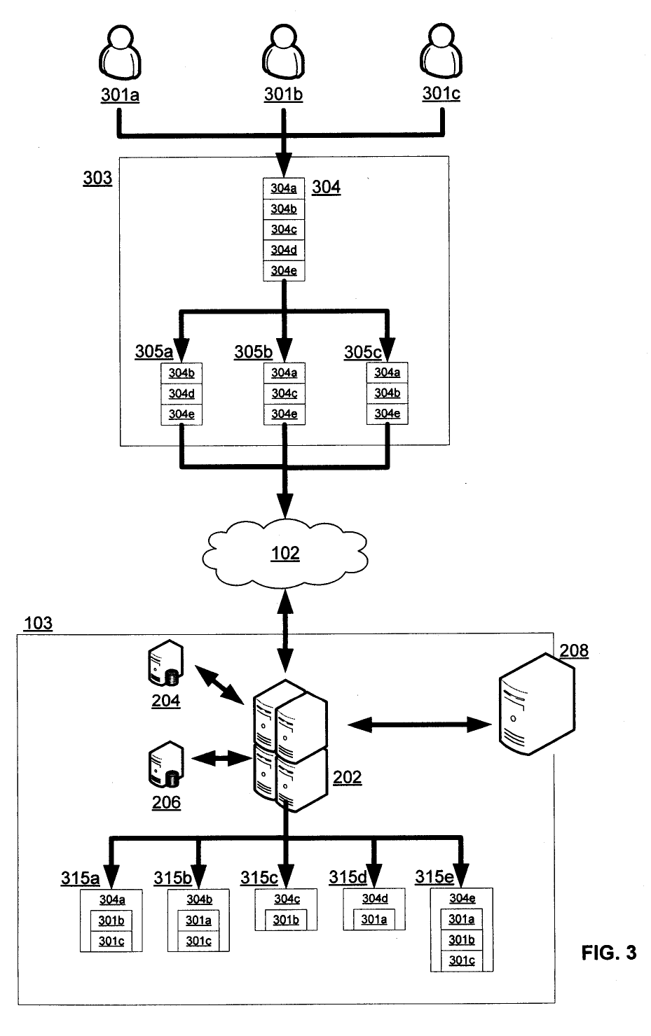

FIG. 3 illustrates an exemplary process of constructing vendor fulfillment packages from request packages, according to one embodiment. Consumers 301 interact with menu system 303 available on a television set 121, STB 123 or a computer 122. For the purpose of illustration, three consumers 301a-301c, three request packages 305a-305c, five products 304a-304e and five vendor fulfillment packages 315a-315e are shown but any number of consumer, request packages, products and vendor fulfillment packages might be considered. Consumers 301a-301c using menu system 303 choose one or more products 304a-304e from product list 304, and request packages 305a-305c from each consumer 301 are sent to processing server 202. Let's assume that each consumer 301's request package 305 contains different products. For example, consumer 301a's request package 305a contains product 304b, 304d and 304e; consumer 301b's request package 305b contains products 304a, 304c and 304e; and consumer 301c's request package contains product 304a, 304b and 304c. Each request package 305 including shipping information 200d and payment information 200e is transmitted to processing server 202 via two-way communications platform 102. Processing server 202 accesses product database 204 and vendor database 206 to assemble vendor fulfillment packages 315. Processing server 202 also submits payment information 200e to payment processing system 208. Payment requests are processed in a similar way as described earlier. In the example shown in FIG. 3, vendor fulfillment package 315a contains purchase requests from consumers who ordered product 304a. Vendor fulfillment packages 315b-315e also contain similar information regarding products 304b-304e that originated from respective vendors.

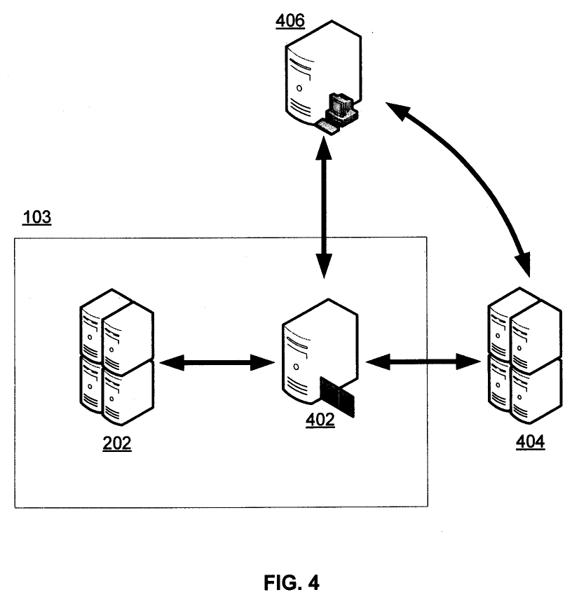

FIG. 4 illustrates exemplary processes for processing payment of a consumer's request, according to one embodiment. Processing server 202 can process payment requests in various ways. Processing server 202 transmits a consumer 101's payment request contained in request package 200 to merchant server 402. According to one embodiment, merchant server 402 communicates with a third party merchant server 404 that communicates with credit card company 406 on behalf of processing server 202. For example, the third party merchant server 404 is an E-commerce server such as PayPal that processes payment using a pre-deposited virtual wallet or direct withdrawal from a bank account. According to another embodiment, merchant server 402 processes the payment request through direct communication with credit card company 406. Datacenter 103's merchant server 402 may have its own virtual wallet service for direct deposit or bank account withdrawal system. Processing server 202 then outputs confirmation of payment or confirmation of sufficiency of funds for transmission to vendor 105 for their fulfillment of the purchase request.

According to one embodiment, payment information 212c is passed on to vendor 105 so that processing server 202 is not involved in payment transactions. In this case, processing server 202 performs all the other transactions described earlier and prepares vendor fulfillment packages 211 including the payment information 212c therein. Each vendor 105 receiving vendor fulfillment package 211 performs payment processing and notifies the success or failure of the payment request. Whether the payment request is processed by processing server 202 or vendor 105, the payment process is transparent to consumer 101 who initiated the purchase request. In an alternate embodiment, a request to verify sufficiency of funds is only made, and the payment transaction is completed by the vendor at a later time.

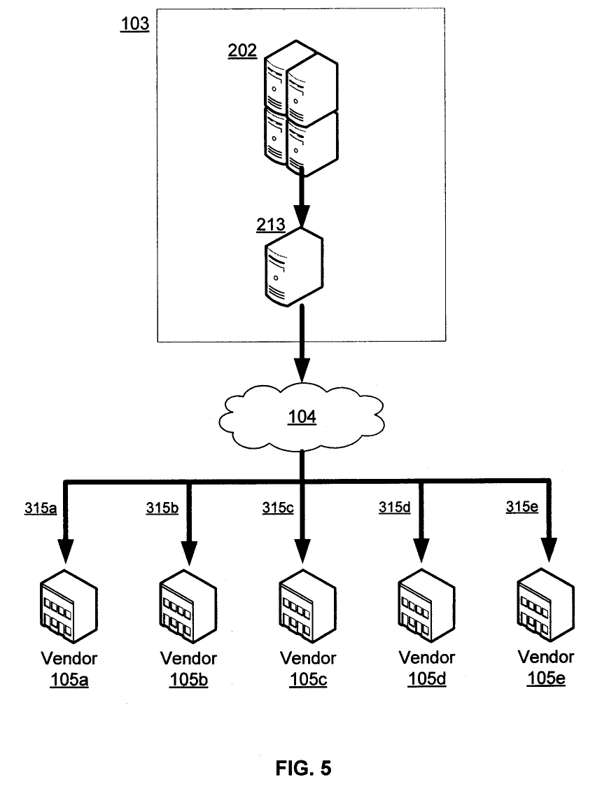

FIG. 5 illustrates an exemplary process for distributing vendor fulfillment packages 315 to vendors 105, according to one embodiment. Processing server 202 sends vendor fulfillment packages 315 to deployment server 213. Vendor fulfillment packages 315 are delivered to vendors 105a-105e either in a standard format utilized by them or a translated format that works with commerce transactional system 100 which vendors 105 have adopted. Deployment server 213 transmits vendor fulfillment packages 315 to vendors 405 through network 104 or any available means of communication. Deployment server 213 directs vendor fulfillment package 315a-315e to vendors 105a-105e who originated the product purchased by consumers 101. For example, vendor fulfillment package 315 a contains one or more products created and/or carried by vendor 105a, thus vendor fulfillment package 315a is transmitted only to vendor 105a. In a similar fashion, other vendor fulfillment packages 315b-315e are delivered to vendors 105b-105e. Although the present example shows that each vendor fulfillment package 315 is delivered to each vendor 105, other ways of packaging and delivering may be employed without deviating from the present subject matter. For example, multiple vendor fulfillment packages containing purchase requests from multiple consumers may be combined to reduce the number of transactions between datacenter 103 and vendors 105. In cases where a product is offered by multiple vendors, different vendor fulfillment packages may contain the same product designated to different vendors.

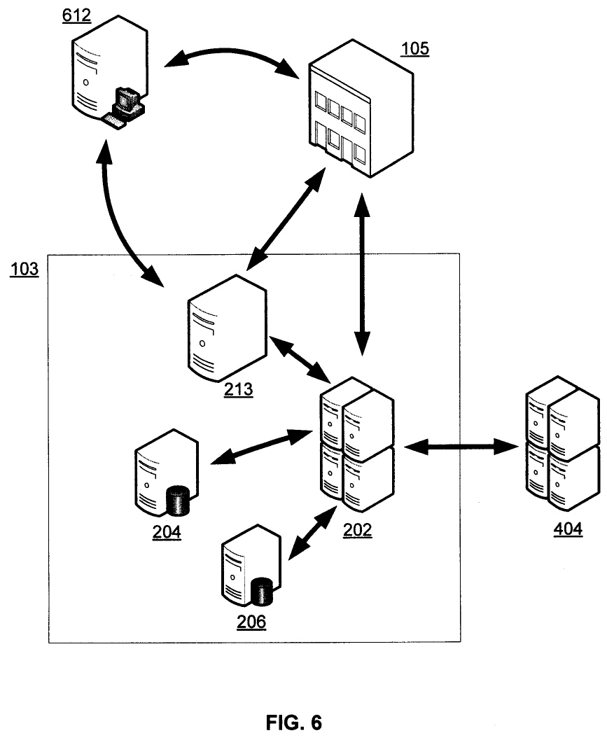

FIG. 6 illustrates an exemplary process for updating product and vendor information, according to one embodiment. Datacenter 103 not only processes consumer 101's purchase requests but also receives product and vendor information for display to consumers. Vendor 105 submits product data for products that it carries to processing server 202. Updated product data is stored in product database 204, which later becomes available to consumer 101 through the menu system 303 supplied by MSO or any other system that offers products to consumer 101. Vendor 105 may also submit its updated vendor information as an account holder with datacenter 103 including updated fulfillment instructions to facilitate vendor fulfillment with datacenter 103. The updated vendor information is stored in vendor database 206 and is accessed by processing server 202 when the vendor information is needed. When a request package 200 is submitted by consumer 101, processing server 202 accesses product database 204 for product information, and vendor database 206 to determine the vendor from which the product originates. Processing server 202 outputs vendor fulfillment package 315 to deployment server 213. To find the location address to which the vendor fulfillment package 315 is to be transmitted, deployment server 213 may access vendor database 206 or processing server 202 that can access vendor database 206. To reduce the data traffic between deployment server 213 and processing server 202 or vendor database 206, the location address for listed vendors may be copied to a local database in deployment server 213. Vendor fulfillment packages 315 are transmitted, via network 104 or any other communications method connecting vendors 105 and datacenter 104. According to one embodiment, vendor fulfillment packages 315 are directly delivered to vendors 105 or indirectly delivered to other alternative fulfillment centers 612.

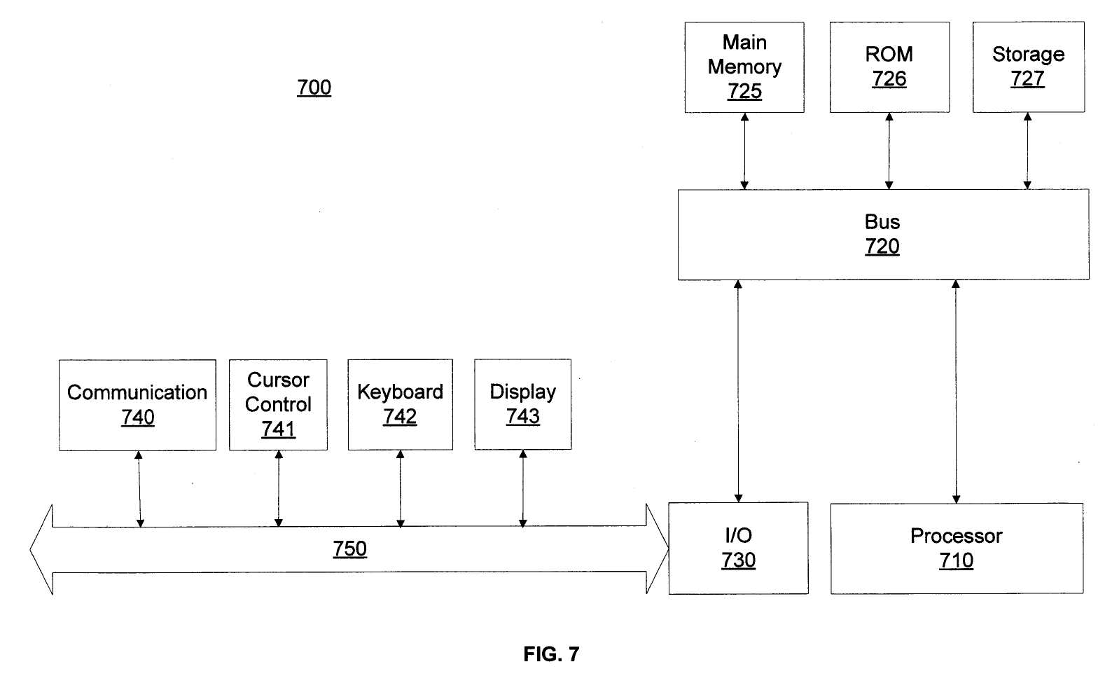

FIG. 7 illustrates an exemplary computer architecture 700 for use with the present system, according to one embodiment. Computer architecture 700 can be used to implement a consumer 101's computer 122, MSO 102a, processing server 202, deployment server 213. One embodiment of architecture 700 comprises a system bus 720 for communicating information, and a processor 710 coupled to bus 720 for processing information. Architecture 700 further comprises a random access memory (RAM) or other dynamic storage device 725 (referred to herein as main memory), coupled to bus 720 for storing information and instructions to be executed by processor 710. Main memory 725 also may be used for storing temporary variables or other intermediate information during execution of instructions by processor 710. Architecture 700 also may include a read only memory (ROM) and/or other static storage device 726 coupled to bus 720 for storing static information and instructions used by processor 710.

A data storage device 727 such as a magnetic disk or optical disc and its corresponding drive may also be coupled to computer system 700 for storing information and instructions. Architecture 700 can also be coupled to a second I/O bus 750 via an I/O interface 730. A plurality of I/O devices may be coupled to I/O bus 750, including a display device 743, an input device (e.g., an alphanumeric input device 742 and/or a cursor control device 741).

The communication device 740 allows for access to other computers (servers or clients) via a network. The communication device 740 may comprise a modem, a network interface card, a wireless network interface or other well known interface device, such as those used for coupling to Ethernet, token ring, or other types of networks.

A method and system for processing consumer's purchase request in an interactive environment has been described with respect to specific example and subsystems. It will be apparent to those of ordinary skill in the art that it is not limited to these specific examples or subsystems but extends to other embodiments as well.

We claim:

1. A computer-implemented method, comprising:
generating a request package from commands received at a set top box;
receiving the request package over a cable network, the request package including a product identifier;
retrieving product information from a product database using the product identifier;
retrieving vendor information using the product identifier; and
sending a vendor fulfillment package to a deployment server.

2. The computer-implemented method of claim 1, wherein the request package includes payment information.

3. The computer-implemented method of claim 2, further comprising providing the payment information to a merchant server that processes the payment information.

4. The computer-implemented method of claim 1, wherein the request package includes a shipping address, a billing address, a phone number, and an e-mail address.

5. The computer-implemented method of claim 4, wherein the vendor fulfillment package is sent to the deployment server over the Internet.

6. The computer-implemented method of claim 5, further comprising sending the product information to the set top box.

7. The computer-implemented method of claim 5, further comprising receiving additional product information at the set top box from the product database when additional commands are received at the set top box.

8. The computer-implemented method of claim 7, wherein the set top box displays multiple products on a screen, wherein the multiple products each have a unique product identifier.

9. The computer-implemented method of claim 7, wherein the vendor information is returned to the set top box.

10. The computer-implemented method of claim 3, wherein the merchant server receives a payment verification from a third party payment server and returns the payment verification.

11. A computer-readable medium having stored thereon a plurality of instructions, the plurality of instructions when executed by a computer, cause the computer to perform:
generating a request package from commands received at a set top box;
receiving the request package over a cable network, the request package including a product identifier;
retrieving product information from a product database using the product identifier;
retrieving vendor information using the product identifier; and
sending a vendor fulfillment package to a deployment server.

12. The computer-readable medium of claim 11, wherein the request package includes payment information.

13. The computer-readable medium of claim 12, having stored thereon additional instructions, said additional instructions when executed by a computer, cause said computer to further perform providing the payment information to a merchant server that processes the payment information.

14. The computer-readable medium of claim 11, wherein the request package includes a shipping address, a billing address, a phone number, and an e-mail address.

15. The computer-readable medium of claim 14, wherein the vendor fulfillment package is sent to the deployment server over the Internet.

16. The computer-readable medium of claim 15, having stored thereon additional instructions, said additional instructions when executed by a computer, cause said computer to further perform sending the product information to the set top box.

17. The computer-readable medium of claim 15, having stored thereon additional instructions, said additional instructions when executed by a computer, cause said computer to further perform receiving additional product information at the set top box from the product database when additional commands are received at the set top box.

18. The computer-readable medium of claim 17, wherein the set top box displays multiple products on a screen, wherein the multiple products each have a unique product identifier.

19. The computer-readable medium of claim 17, wherein the vendor information is returned to the set top box.

20. The computer-readable medium of claim 13, wherein the merchant server receives a payment verification from a third party payment server and returns the payment verification.
